(19) United States
(12) Patent Application Publication
(10) Pub. No.: US 2014/0144929 A1
(43) Pub. Date: May 29, 2014

(54) THERMOPLASTIC COMPOSITIONS AND THEIR APPLICATION

(71) Applicants: Dennis J. Fitzmeyer, Hampton, NH (US); Richard A. Belanger, Hampton, NH (US); Peter S. Melendy, Hampton, NH (US)

(72) Inventors: Dennis J. Fitzmeyer, Hampton, NH (US); Richard A. Belanger, Hampton, NH (US); Peter S. Melendy, Hampton, NH (US)

(73) Assignee: Adhesive Technologies Inc., Hampton, NH (US)

(21) Appl. No.: 13/978,906

(22) PCT Filed: Jan. 11, 2012
(86) PCT No.: PCT/US12/20974

§ 371 Date: Jan. 21, 2014

Related U.S. Application Data
(60) Provisional application No. 61/431,597, filed on Jan. 11, 2011.
(60) Provisional application No. 61/538,877, filed on Sep. 25, 2011.

(51) Int. Cl. B05C 17/00

(52) U.S. Cl. CPC B05C 17/001
USPC 222/1; 222/146.2

(57) ABSTRACT

A system for applying heated compositions includes a heated supply tank for receiving and supplying a composition at a first temperature, and a heated discharge chamber for receiving the composition from the supply tank, heating it further to a desired temperature, and discharging the composition for its end use. The system may be a bulk dispenser or a hand-held glue gun. In preferred embodiments, the compositions are hot melt adhesives, particularly hot melt adhesives of reduced density.

### TECHNICAL FIELD

This invention relates to the art of thermoplastic compositions and their application. In particular, the invention relates to improvements in systems for handling these compositions and for controlling their application temperatures. The invention is applicable to thermoplastic compositions including hot melt adhesives generally, hot melt adhesives of reduced density, and compositions, including hot melt compositions, with heat-activated properties.

### BACKGROUND ART

Application of thermoplastic compositions presents several problems. One such problem is related to achieving the optimum application temperature. For example, compositions that have been heated may char due to increased oxidation if the composition is held at an elevated temperature for an extended time period, which reduces the effectiveness of the composition when applied. As well, the equipment used in handling and applying these compositions at elevated temperatures may be temperature-sensitive, and lowering the temperature of the compositions may reduce temperature-related degradation of such equipment.

Another problem arises in the application of compositions with additives. Recent increases in the price of petroleum based materials has highlighted a significant problem with 100% solid thermoplastic adhesives—commonly known as hot melt adhesives and hot melt polyurethane reactive adhesives. These adhesives have most of their raw material components derived from either petroleum or other forms of hydrocarbon materials. Hot melt adhesives are traditionally 100% solid thermoplastic, which in their traditional designs comprise a polymer backbone, which might be EVA, PE, P/P or similar thermoplastic polymer that is modified with tackifying resins and waxes to improve tack, viscosity and set time. The specific gravity of most of these materials is around 1 although some polymers, such as polyamides and urethanes, might be greater than 1.3.

There have been many attempts to use extenders to lower the overall cost of these adhesives. For example limestone has been a favorite for years as it was cheap and relatively inert with respect to the hot melt raw materials and its relatively high specific gravity allowed filled hot melts made with this material to have a low cost per pound and low cost per application. But the overall specific gravity of this filled hot melt was often 1.5 times that of a ‘pure’ unfilled hot melt and the overall performance of this hot melt was generally relegated to bookbinding and edge-banding due to the higher viscosity and lower bond strengths of this material. Glass beads, both hollow and solid, have also been used, but once again these tend to add to the overall specific gravity of the resultant hot melts as well as to increase the application viscosity. These more traditional approaches to ‘extending’ hot melt adhesives dilute the hot melt with little further benefit to the bond strength or other properties of the hot melt. Furthermore while these may have ‘extended’ the hot melt—the relative mass of adhesive applied was often higher per unit application than an unfilled hot melt due to the higher specific gravity of the adhesive.

Those approaches are not ideal for the broader applications of hot melt in packaging and product assembly where volume of application must be controlled precisely and where higher viscosity is a liability. In these applications, a better solution, focused upon the true volume of adhesive applied is required. Alternative adhesives, such as alcohol based or water based systems are often glue lines where the ultimate adhesive solids might be less than 50% of the ‘glue line.’ These adhesives rely upon evaporation of the volatiles to leave behind an effective glue bond. That process takes time and pollutes the environment, which hot melts don't. However, as the cost of petroleum based raw materials increases, these alternative systems have an advantage because a smaller percentage of the raw materials is actually tied to the cost of petroleum.

Hot melts have become a preferred choice for many non-structural adhesive applications. They are relatively inexpensive, easy to apply, and they are fast because there is no delayed bond due to the evaporation of solvents or water. But, cost increases in petroleum materials are significant because these hot melts are 100% solid. Any increase in the cost of the adhesive raw materials must be borne by the hot melt itself, unlike the water or solvent based systems where the adhesive solids are less than 50%.

Attempts have been made to lower the density of the applied hot melt by dissolving compressed air or gas (e.g., CO₂ or N₂) into the hot melt material. This was tried in the mid-1980s, and equipment was developed to accomplish it. However, this proved to be of limited market appeal for different reasons—it required a special application system which was expensive as well as a supply of compressed gas. The foamed glue line also had a higher viscosity, and the glue line would typically collapse as the compressed gas escapes the bond line when the bond lines on the substrates being bonded are pressed together. Continuing marketing efforts of these products demonstrates that there is a need for lower density hot melt adhesives.

### SUMMARY OF THE INVENTION

In accordance with the invention, a system for applying compositions including hot melt adhesives utilizes a system that heats the composition to a first temperature to permit handling and supply of the composition in a generally fluid state and then heats the composition further to a second temperature just prior to application of the composition for a particular end use. Thus, the system of the invention provides a heated supply chamber for receiving a composition and heating it to the first temperature. This supply chamber may be a bulk tank with an elongated supply hose or a smaller chamber associated with a hand-held unit. The system further includes a discharge chamber that heats the composition received from the supply chamber to an appropriate application temperature. The temperature of the composition in the supply chamber is preferably that which reduces or prevents undesired physical or chemical changes, such as char, and also reduces deleterious effects of the increased temperatures on the supply equipment itself. The temperature of the discharge chamber is preferably the optimum application temperature, which may be that which optimizes bond qualities, reduces density because of expansion of added components, or activates catalysts or other chemical reactions.

In accordance with a particular feature of the invention micro-spheres, or micro-balloons, such as those marketed under the trademark EXPANCEL are added to conventional hot-melt formulations to reduce the density of the glue as applied. The new formulations provide greater control of the glue application, provide greater heat resistance, and enhance the bond line in other unique and unforeseeable ways.

Micro-balloon technology is documented and used, for example, to lower the density of many polymers, generally in molding and extrusion applications. In a known use, micro-balloons are expanded by application of heat, usually through molding or extrusion and then ‘frozen’ into these polymers as they cool. The micro-balloons in the prior art have no role other than to lower the density of the polymer. The micro-balloons are designed to expand in specific temperature ranges by the softening of the exterior acrylonitrile polymer shell, which allows a volatile gas in the micro-balloon to expand. These micro-balloons are relatively stable up to about 350° F., and, once expanded, stay expanded. Above about 350° F. the micro-balloon shell weakens, because of the temperature and the internal pressure, and they rupture and collapse under continuous exposure to these elevated temperatures.

In accordance with the invention, relatively stable expanded micro-balloons lower the density of the hot melt adhesive. Unlike the micro-bubbles in known blowing-agent type applications of gasses, the micro-balloons of the invention remain a stable component of the bond line. That is, they do not collapse or migrate out of the bond, as do the micro-bubbles. As a result, the micro-balloons form an integral component of the final hot melt adhesive matrix.

Applicants have found that this feature provides further benefit to the general hot melt adhesive bond strength as determined traditional measures such as tensile strength and heat resistance. The micro-balloons reduce the specific gravity of the hot melt material as a function of the concentration of the micro-balloons.

In preferred embodiments the micro-balloons are about 0.5% to about 2% by weight of the overall hot melt composition and preferably 1% to 2%. The net overall density reduction is significantly greater than the cost of the micro-balloons, as measured by the unit volume cost of the adhesive.

Formulations according to the invention have been found to provide unanticipated increases in bond strength, the nominal bond strength of a hot melt with micro-balloons being 15-30% larger, based upon traditional bond measurement methods. This unexpected benefit allows many unforeseen options to formulate both unique hot melts and to use non-traditional raw materials such as soybean and corn oil to improve performance and lower costs.

Micro-balloon formulated hot melts tend to have higher viscosity, when the micro-balloons are expanded, than the formulas without micro-balloons. This increase can be 30-70% depending upon the actual percentage of micro-balloons added to the formula. The presence of the micro-balloons has also shortened the ‘open time’ of the unfilled hot melt formula.

Applicants have found that diluents can be added to micro-balloon formulas to offset the higher viscosities. For example mineral oils, corn oils and soybean oils, at loading levels of about 10% have been used. While reducing the viscosity of the overall formula, these diluents have not had a significant impact on the increased bond strength.

Excellent adhesion is achieved with the reduced-density formulas of the invention. In addition, applicants have discovered that formulations in accordance with the invention have a heat resistance that is increased by 10 to 25 degrees F. That is, known formulations that have a heat resistance of about 145° F. exhibit a heat resistance of about 160° F. when provided with the microspheres as described herein.

Applicants have developed two systems to apply these micro-balloon formulas. The preferred alternative for bulk based formulas is to allow the micro-balloons to expand only after they have exited the melt tank or a drum unloader system. This can be done by providing a small heat exchanger in line with the hose of the system to raise the temperature of the mixture to activate the micro-balloons so that they expand. If the micro-balloons are allowed to expand while in a traditional tank, they tend to separate over time from the molten hot melt, resulting in a non-uniform hot melt mix in the melt tank. The post-tank approach limits the time of expansion so that the micro-balloons do not separate from the hot melt mix and ensures that the lower density hot melt is consistently applied through the nozzle.

A known bulk glue machine typically has a gear pump at its outlet to pump melted glue into a dispensing hose. The pump need not necessarily be a gear pump, however, and may be any of several other kinds of pump, such as an air-driven piston pump. In accordance with another feature of the invention, a temperature-controlled check valve is attached, for example by a threaded fitting to the exit port of the pump. In a preferred embodiment, the check valve is a ball check valve. The valve is preferably heated to ensure that the glue flows through the valve easily and the valve functions properly. In the preferred embodiment, the ball check valve is spring-biased to provide approximately a 15 PSI pressure to open. The check valve ensures that the glue, which has passed through the check valve, is held in the hose with the spheres suspended in the glue in an unexpanded condition. This is achieved by the check valve maintaining the pressure in the hose. Thus, the hot melt with suspended unexpanded spheres is introduced into the hose under pressure and maintained under pressure by the check valve. It then passes through the heat exchanger, thus softening and partially expanding the gas-filled Expancel spheres until it exits the dispensing nozzle, and the spheres then fully expand due to the lower ambient pressure.

A typical gear pump in a bulk glue machine is controlled by a micro switch in a hand-held applicator that actuates a motor that runs the pump. The pump is most efficient when pumping non-compressible liquids, and this is ensured in the preferred embodiment by providing a check valve. Unless the pressure in the hose is maintained separately from the pressure in the pump, as by the use of a check valve, the pressure in the hose created by the pumping pressure of the pump as well as the increased temperature of the hose and the heat exchanger could allow semi-expanded glue to back-up into the pump as the hose gives up its pressure due to volumetric expansion when the pump is not activated. At this point, the pump would be less efficient, trying to pump a partially compressible (spongy) liquid. Further, if the pressure in the hose were allowed to “relax,” for example when the pump is not running, there would be a time lag between actuation of the dispensing gun by the operator and the dispensing of a proper formulation because the spheres in the hose would have begun to come out of suspension during the period of reduced pressure, resulting in the extruded glue initially having an uneven blend of liquid and beads. Thus it important to maintain the pressure in the hose when the pump is not running, as by use of the check valve, to provide a well-blended, foamed product with instantaneous action at the gun's nozzle. Use of other mechanisms which maintain the pressure in the hose or maintain the spheres in suspension will be apparent to those of skill in the art. For example, the vessel itself could be pressurized, or the gear pump could be provided with clearances that would cause it to hold pressure during non-pumping periods.

It will be appreciated that in some instances the check valve at the output of the supply chamber is not necessary. One instance would be where there is little or no expansion of the composition due to heating. Examples of this are where the composition does not have expanding components and the temperature in the supply chamber is reduced primarily to reduce char, or where the temperature is low enough that expansion of the composition with expanding components in the supply chamber or supply hose is not an issue.

An approach for a portable hot melt adhesive glue gun is to expand the micro-balloons during production of glue slugs or sticks. The production process of these slugs or sticks can be rapid enough that the resultant glue stick or slug cools and holds the expanded or partially expanded micro-balloons uniformly in the stick or slug. The stick/slug can then be introduced into a glue gun, melted, and used at a rate that does not allow the micro-balloons to migrate out of the hot melt mixture, whereby the benefits of the lower density are realized. This approach makes this technology available for existing glue guns, as the fully expanded micro-balloons do not exert any significant pressure inside the melt chamber. Alternatively, these sticks or slugs are used in a known applicator modified to hold pressure in the melt chamber, or a hand-held two-chamber applicator as described below.

It is within the scope of the invention also to provide a two-stage melt system for a portable hand-held glue gun. In this embodiment, a hand-held glue gun largely mimics the physics and fluid mechanics of the bulk system described above. A sealed melting (discharge) chamber would be provided with a pressurization source capable of holding the chamber at a pressure that would maintain the spheres or blowing agent in suspension, and a nozzle attached to the melting chamber would be actuated to dispense the glue.

Applicants have also found that chemical blowing agents can be used with the equipment described.

### BRIEF DESCRIPTION OF THE DRAWINGS

FIG. 1 is a schematic diagram of a preferred machine for application of hot melt adhesives in accordance with the invention.

FIG. 1A is a schematic diagram of another embodiment of the invention.

FIG. 2 is a longitudinal cross section of a preferred heat exchanger in accordance with the invention.

FIG. 2A is a transverse cross section of the heat exchanger shown in FIG. 2.

FIG. 3 is a partial transverse cross section of a preferred check valve assembly.

FIG. 4 is a schematic view of a hand-held unit in accordance with the invention.

### DETAILED DESCRIPTION OF THE PREFERRED EMBODIMENTS

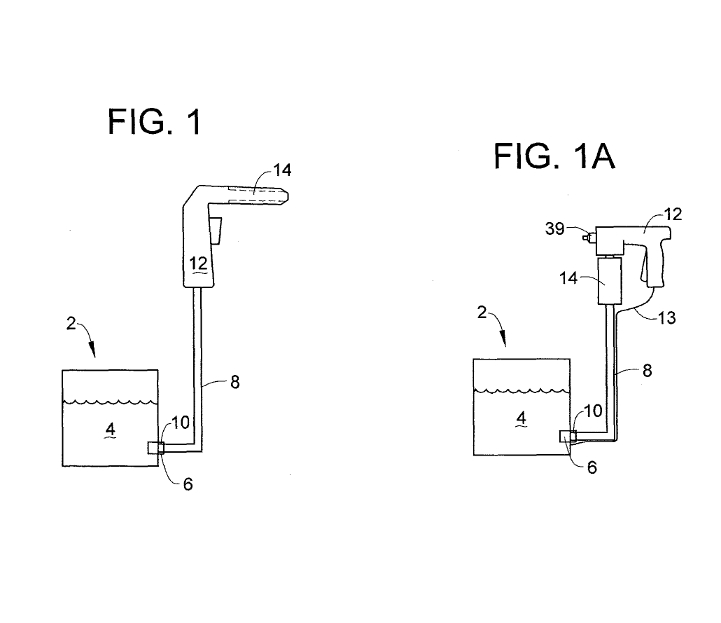

With reference to FIG. 1 a system in accordance with the invention is shown schematically. The system comprises a melting chamber 2 for receiving a mixture 4 of a known hot melt formulation and micro-spheres (micro-balloons). Alternatively the mixture comprises a known hot melt formulation and a chemical blowing agent.

A pump 6, which is preferably a gear pump is located at the outlet of the melting chamber and is connected to a supply hose 8. A check valve 10 is placed between the outlet of the pump 6 and the inlet of hose 8. The end of the hose remote from the melting chamber is attached to an applicator 12, which includes a heat exchanger 14.

FIG. 1A shows a second embodiment of the invention where the heat exchanger 14 is attached to the inlet of an applicator, which includes a micro-switch (not illustrated), connected to the pump by electrical connection 13 to control operation of the pump in accordance with the operation of a trigger on the applicator. It will be appreciated that heat exchanger 14 could also be located at the outlet of the check valve, or the pump if a check valve is not employed.

A second check valve 39 is preferably provided at the outlet of the applicator to maintain pressure in the discharge heat exchanger 14.

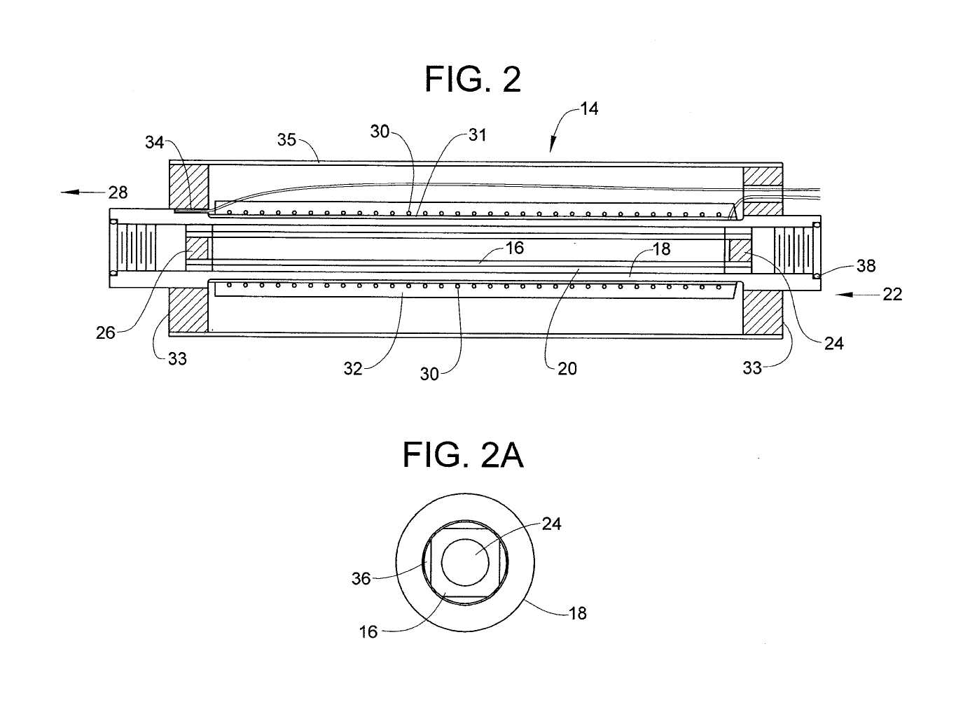

FIG. 2 illustrates a preferred heat exchanger 14. Heat exchanger 14 includes a central tube 16 surrounded by an outer tube 18 to form an annular heating chamber 20 between them. The hose 8 is connected to the inlet 22 of the heat exchanger, and a plug 24, which can be chamfered, directs the incoming mixture to the annular chamber 20. At the opposite end of the tube 16 a second plug 26, which can also be chamfered, directs the heated mixture to the outlet 28. The outlet may be connected to a nozzle having a check valve for dispensing the heated mixture at an appropriate pressure, as shown in FIG. 1, or to the inlet of an applicator as illustrated in FIG. 1A.

Outer tube 18 is wrapped with a heating wire 30 to provide about 500 W power, in the preferred embodiment. The heat exchanger is also provided with insulation 32.

The central tube 16 preferably is of very low mass, e.g., machined aluminum, to reduce the weight of the heat exchanger and to improve its response time. Tube 16 is provided at each end with a respective plug 24 and 26. As shown in FIG. 2A, the tube 16 is provided with four openings 36, which can be cut into each end of the tube (machined flats) or, alternatively, the plugs, to allow the glue to enter or exit the space 20 between the OD of the center tube 16 and the ID of the outer tube 18. The center tube 16 is secured by press-fit into the outer tube 18. The ends of the outer tube 18 are sized and threaded with a thread that accommodates the standard fittings used in most bulk glue machines. The fittings used tighten and seal to the heat exchanger ends with O-rings 38 (preferably of Viton) to guarantee pressure tight connections. The OD of the outer tube 18 tube is wrapped with a suitable electrical insulator material 31, such as Processed Mica Paper or Kapton. A suitable Nichrome wire 30 is calculated to produce 500 watts, as an example, and the turns are calculated to be evenly spaced. The ends are secured by two wraps of 0.025 annealed stainless steel wires. An outer layer of similar electrical insulation (not shown) is wrapped and secured by stainless steel wire. A suitable thermal insulator 32 such as foamed silicone sheet is wrapped and secured around the internal assembly.

End caps 33, preferably machined from Teflon, are fitted to each end of the outer tube and secured by set screws. To these Teflon end caps, an outer shell 35 of e.g., G10 (epoxy impregnated fiberglass) is screwed to house the whole unit and make it electrically insulated and therefore safe. Four wires, two electrical wires and two thermocouple wires are passed through a hole in one end cap and insulated and routed to the base of the machine.

The heat exchanger exhibits high power-to-mass ratio as well as a low-mass highly responsive temperature sensing and control method. In the preferred embodiment, a J-type wire thermocouple 34 is used to provide a signal to a very responsive analog temperature controller. The time for responding to a change in temperature of the heat exchanger is preferably kept very short both to turn on the heat quickly but also to prevent overshoot that could overheat the melted product causing separation of the bubbles as well as char of the product. The preferred temperature setting of the system when used with reduced density hot melts having expanded microspheres described herein and other know thermoplastic compositions is in the range of 350° F. to 400° F. Other compositions may require different temperatures.

An adjustable temperature controller is preferably housed in a custom control box that can be attached to or part of the supply chamber 2 and contains the J thermocouple analog temperature controller, an on/off switch, a pilot light, a fuse, and a terminal block as well as a 120V single outlet to plug the heater control box into. The wires from the heat exchanger are connected to the terminal block on the control box whose connections are appropriately connected internally in the box. The controls noted can be in a separate control box, integrated with other parts, or dispersed among various locations. The elements may be placed in any of several locations, such as in or on the supply chamber, in the applicator, or as a completely separate unit.

It will be appreciated that the described heat exchanger is illustrative only and that many different heat exchanger designs may be used, depending on the required heating requirements, available surface area, mass flow, and desired temperature increase.

In operation, the melting chamber is maintained at a temperature whereby the mixture can be pumped but the micro-spheres are not significantly expanded (or the chemical blowing agent not significantly activated). For example, this can be about 250° F. for the preferred materials. The hose 8 is preferably provided with a heating wire that supplies about twenty watts per foot to maintain the temperature of the mixture but not to increase it to any significant degree. This temperature may be controlled to a desired temperature by application of more or less current to the heating wire. The primary objective is to maintain the fluidity of the mixture without causing significant expansion of the micro-balloons.

There is, however, some expansion of the micro-balloons, which increases the pressure in the hose. The check valve 10, however, prevents reverse flow of the mixture into the melting chamber as discussed above.

The heat exchanger preferably increases the temperature of the mixture from an inlet of about 250° F. to about 350° F. At the increased temperature, the micro-balloons in the mixture expand to reduce the density of the mixture by about 20% to 40%. This increases the pressure of the mixture in the heat exchanger, and this pressure is held between the outlet (discharge) check valve 39 and the check valve 10 at the melting chamber. When the dispenser is activated the melted mixture is applied to the substrate to be bonded, the microspheres expanding further to reduce the density to the desired degree.

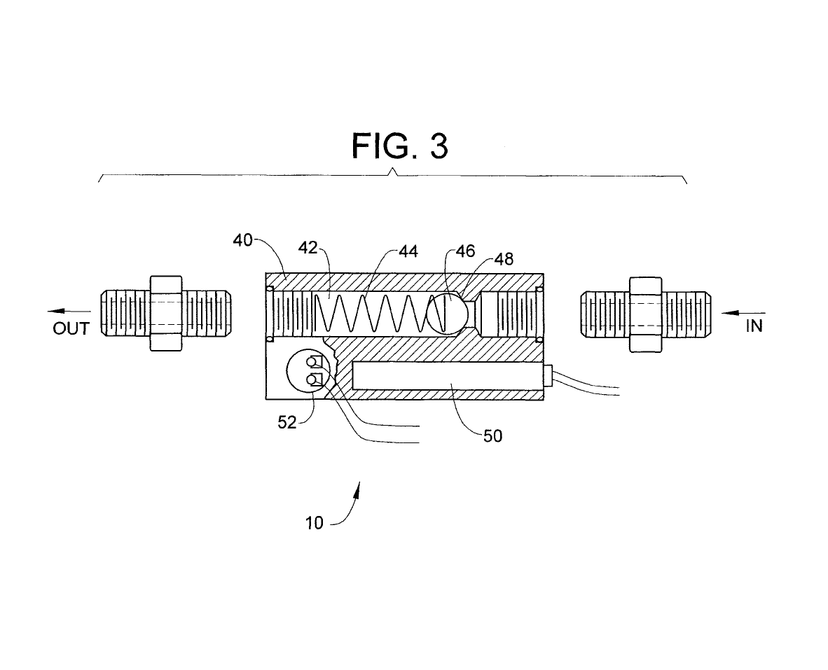

A preferred ball check valve 10 is shown in FIG. 3. The check valve includes a housing 40 that provides a ball valve cavity 42, which receives a spring 44 and a ball 46, which engages a seat 48 when closed. A heater cartridge 50 is placed in a cavity in the housing, and a thermostat 52, which may be surface mounted, is connected to the heater to maintain the temperature whereby the glue flows smoothly and the ball valve operates properly.

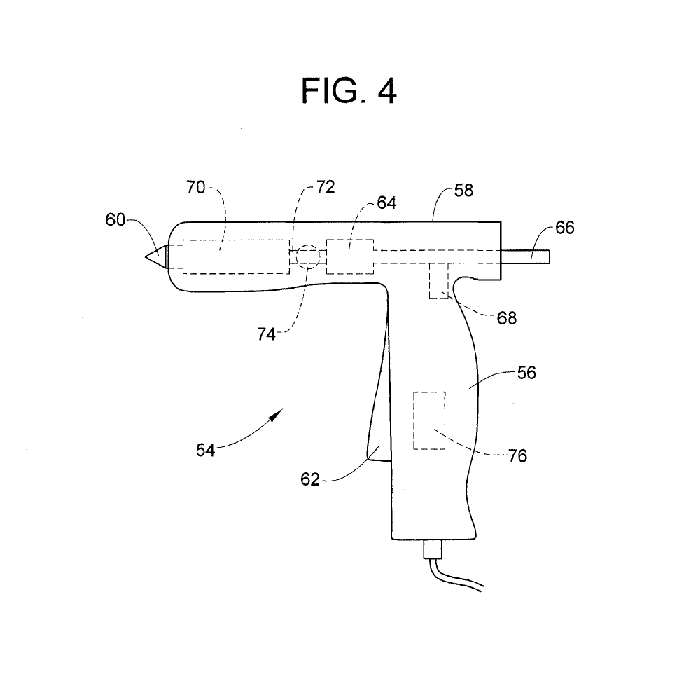

FIG. 4 shows a hand-held unit 54 having a housing forming a handle portion 56 for gripping by a user and an upper portion 58, which includes a discharge outlet 60, which preferably includes a check valve. The unit may be activated by a trigger 62 or other structure, such as a button, thumb-operated device, or the like. Unit 54 includes a supply chamber 64, which as described above will heat a composition to a first temperature, such as the liquefying temperature of glue that is provided to the supply chamber from glue stick 66. The glue stick may be advanced into the supply chamber by an advancing mechanism 68 connected to the trigger 62, structures for which are known in the art. The supply chamber 64 is preferably provided with a seal to prevent melted glue from leaking out of the chamber around the periphery of the glue stick at the entrance of the glue stick to the supply chamber. It will be appreciated that the glue or other composition may alternatively be provided to the supply chamber from other sources, such as chips that are placed in the supply chamber through a door or similar opening (not shown).

The hand-held embodiment of FIG. 4 is further provided with a discharge chamber 70, which heats the composition to a higher temperature as discussed above. The composition may be provided to the discharge chamber from the supply chamber by a conduit that includes a check valve 74. The check valve 74 operates essentially as the check valve 10 discussed above.

A control box 76 is provided to house electronic components required for sensing and controlling temperatures in the chambers 64 and 70.

Preferred formulations according to the invention generally comprise known hot melt mixtures comprising, for example an EVA based polymer, a tackifier, and wax. Other formulas comprise rubber based, hot-melt formulas, PE based hot melts, and APO-based formulas. The hot melt formulas are mixed with expanding micro-balloons including those sold under the trademark EXPANCEL having model numbers 091DE, 091DU, 950 DU, 950 DU 120, 950 DET, and 10 015; and those sold under the trademark HENKEL having the model number DLU 010-185 D01. As well, the hot melt formula may be mixed with a chemical blowing agent, such as that sold under the trademark CELOGEN having model numbers TSH or Endex 9900 MF. Still further, the hot-melt formulations may include 25P45 glass spheres or 60P18 glass spheres.

Applicants have also found that in addition to a reduction in density, the formulations having expanded micro-balloons provide unexpected increases in heat resistance and bond strength. An increase in heat resistance is important for those uses of melt formulations in packaging because boxes bonded with hot melt glues are shipped around the world and can be exposed to extremely high temperatures, for example when the boxes are carried in hot or sunny areas in trucks, rail cars, or containers that are not temperature controlled. In such situations, an increase in heat resistance of 10° F. to 15° F. can represent the difference between maintenance of the bond and failure. The increase in heat resistance is illustrated in the following table, which shows the results of a standard heat resistance test where four specimens, each comprising a one-inch wide pine strip bonded to an identical strip by a one-inch overlap joint, are hung in an oven with a 2 pound static load attached to each lower strip to apply a force in shear to the bond. The oven temperature is raised 5° F. every 30 minutes until all four specimens have failed. The oven temperature is recorded at each failure. The results of such a test conducted by applicants are:

TABLE 1
Heat Resistance

| | | AdTech 660 with | AdTech 660 |
|---|---|---|---|
| Oven | AdTech | 1.5% (wt.) | with 1% |
| temp | 660 | Expancel | Expancel |
| (° F.) | (EVA) | (expanded) | (unexpanded) |
| 120 | 1 fail | | |
| 125 | | | 1 fail |
| 130 | 2 fail | | |
| 135 | | | 1 fail |
| 140 | 1 fail | 2 fail | 2 fail |
| 145 | | | |
| 150 | | 1 fail | |
| 155 | | 1 fail | |
| Avg. fail | 130 | 146 | 135 |
| temp | | | |
| (° F.) | | | |

Applicant has also tested the tensile bond strength of adhesive formulations having microspheres in an unexpanded condition for a variety of substrates. In this test, two, one-inch by two-inch test strips are bonded to each other in an X configuration to form a one square inch bond area, and a force is applied to one of the strips in one direction and to the other strip in an opposite direction. The force required to pull the strips apart is recorded. The results of this test are as follows.

TABLE 2
Adhesive Tensile Bond Strength

| | | AdTech 660 with 1% |
|---|---|---|
| | AdTech 660 | (wt.) Expancel |
| | (EVA) | (unexpanded) |
| | Force applied | Force applied in |
| Substrate | in pounds | pounds |
| Pine | 268 | 328 |
| G-10 (phenolic resin) | 176 | 105 |
| PVC | 116 | 134 |
| ABS | 38 | 112 |
| Nylon | 90 | 124 |
| Polycarbonate | 77 | 108 |
| Polypropylene | 66 | 73 |
| HDPE | 98 | 102 |
| Styrene | 53 | 82 |
| Steel | 249 | 345 |
| Average (psi) | 123 | 151 |

Thus, there is an unexpected increase in tensile strength for the basic formulation that has not been heated to a temperature at which the microspheres expand.

Modifications within the scope of the appended claims will be apparent to those of skill in the art.

We claim:

1. A system for dispensing heated fluids comprising a supply chamber having a cavity for containing material and maintaining said material at a first selected temperature, said supply chamber having a chamber outlet through which said material can pass, a discharge chamber connected to said chamber outlet for receiving material from said supply chamber and raising the temperature of said material to a second selected temperature, and a discharge outlet connected to said discharge chamber for discharging said material.

2. A system according to claim 1 wherein said supply chamber comprises a bulk melting tank and said discharge chamber comprises a separate heat exchanger.

3. A system according to claim 1 wherein said supply chamber and said discharge chamber are contained in a hand-held unit.

4. A system according to claim 1 further comprising pressure means for maintaining said material in said discharge chamber under a selected pressure

5. A system according to claim 4 wherein said pressure means comprises a check valve between said chamber outlet and supply chamber.

6. A system according to claim 1 wherein said first selected temperature is that at which a hot-melt adhesive will flow but is below an application temperature and said second selected temperature is said application temperature.

7. A method for applying a heated material comprising providing said material to a system comprising a supply chamber having a cavity for containing said material and maintaining said material at a first selected temperature, said supply chamber having a chamber outlet through which said material can pass, a discharge chamber connected to said chamber outlet for receiving material from said supply chamber and raising the temperature of said material to a second selected temperature, and a discharge outlet connected to said discharge chamber for discharging said material, and discharging said material to an end use.

8. A method according to claim 7 wherein said material comprises a hot melt adhesive having a component that will cause expansion of said material at said second selected temperature.

9. A method according to claim 8 wherein said component comprises microspheres.
